(19) United States
(12) Patent Application Publication
(10) Pub. No.: US 2008/0016762 A1
(43) Pub. Date: Jan. 24, 2008

(54) Wire foliage container with rigid support

(76) Inventor: Bradley Emalfarb, Riverwoods, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/546,615

(22) Filed: Oct. 12, 2006

Related U.S. Application Data
(63) Continuation-in-part of application No. 11/490,404, filed on Jul. 20, 2006.

(51) Int. Cl. A01G 9/02

(52) U.S. Cl. 47/39; 47/66.6

(57) ABSTRACT

A foliage container having a plurality of elongate elements that cooperatively produce at least a part of a wall structure bounding a receptacle into which foliage can be placed, and a base assembly that is configured to be rigidly connected to the wall structure. The base assembly is reconfigurable to cooperate with different types of supports in different manners to maintain the wall structure consistently in an operative orientation.

### CROSS REFERENCE

This is a continuation-in-part of my co-pending application Ser. No. 11/490,404, filed Jul. 20, 2006 and entitled “Wire Foliage Container With Rigid Support”.

### BACKGROUND OF THE INVENTION

1. Field of the Invention

This invention relates to containers for foliage having a receptacle bounded at least in part by wire elements and, more particularly, to containers of this type which can be rigidly connected to a support therefor.

2. Background Art

Containers for foliage, such as plants and flowers, come in a wide range of designs. With the proliferation of decks on homes, there has been a trend towards designing foliage containers that can be displayed seasonally in an attractive manner on these decks. One of the most popular styles of container is that having a receptacle bounded by formed wire. Within the receptacle, either self-contained planters or porous material, such as shredded coconut husk, can be inserted, with the latter offering an alternative to fixed configuration containers.

The wire containers are desirable for a number of reasons. First, the wire containers lend themselves to relatively inexpensive construction. Receptacles of different size and shape can be offered without the high expenses normally associated with customization.

The wire containers are generally light in weight. Thus, they can be shipped relatively inexpensively and handled conveniently by the manufacturers, transporters and end users.

Wire containers lend themselves to nested stacking in a compact manner. This feature also contributes to controlled shipping costs. Additionally, many sizes and shapes of the containers can be displayed in a relatively compact space, thereby potentially maintaining relatively low shelving costs.

Wire containers are commonly made with either fixed dimension, or adjustable, hangers through which they can be conveniently hung from deck rails, on mail boxes, etc. By simply vertically translating the hanging portions of the containers over a rail, the containers can be placed and maintained in an operative state. Users are afforded the convenience of being able to conveniently relocate the containers without performing any complicated steps of removing and re-installing separate fasteners, thereby also avoiding unwanted, and potentially unsightly, modification to the supporting structure for the containers.

The wire containers are also desirable for their aesthetics. The wires alone accent, but do not dominate, the appearance of that placed in the container receptacle. The wires also lend themselves to adornment, to further enhance their visual appeal.

Heretofore, wire containers have been limited generally to loose, hanging installation. While this construction offers great versatility in terms of being able to selectively place and reposition the container in various locations around a deck rail, or the like, this construction has generally been limited to being located wherever inverted, U-shaped hangers can be installed. Generally, this requires a supporting surface that is elongate in a horizontal direction.

The industry continues to seek out designs of these wire containers that afford even additional versatility in terms of where and how they might be mounted so as to increase customer interest in this type of product.

### SUMMARY OF THE INVENTION

In one form, the invention is directed to a foliage container having a plurality of elongate elements that cooperatively produce at least a part of a wall structure bounding a receptacle into which foliage can be placed, and a base assembly that is configured to be rigidly connected to the wall structure. The base assembly is reconfigurable to cooperate with different types of supports in different manners to maintain the wall structure consistently in an operative orientation in relationship to each of different types of support.

In one form, the base assembly has at least a first bracket component that is selectively operatively attachable to the wall structure. The base assembly is configured so that: a) with the first bracket component separate from the wall structure, the base assembly is configured to cooperate with a first type of support in a first manner; and b) with the first bracket component operatively attached to the wall structure, the base assembly is configured to cooperate with a second type of support in a second manner that is different than the first manner.

With the first bracket component separate from the wall structure, the base assembly defines transverse surfaces cooperatively defining an angled receptacle opening in a horizontal direction and into which a support can be directed by being translated horizontally relative to and against the transverse surfaces.

In one form, the base assembly includes a second bracket component that is configured to be selectively operatively attached to the wall structure and defines the transverse surfaces.

In one form, with the first and second bracket components operatively attached to the wall structure, the first and second bracket components cooperatively bound a receptacle for a support for the foliage container.

In one form, with the first and second bracket components operatively attached to the wall structure, the first and second bracket components cooperatively bound a receptacle for a support that has a polygonal shape.

The first and second bracket components may each be selectively operatively attachable to the wall structure through at least one releasable fastener.

The releasable separate fasteners may be threaded fasteners.

In one form, the base assembly has a horizontally extending wall to which the first bracket assembly is separately attachable.

In one form, there is at least one opening in the horizontally extending wall to accept a fastener that can be directed into a support for the foliage container.

In one form, the base assembly has a first bracket component that is selectively operatively attachable to the wall structure and defines a first surface for engaging a support for the foliage container. The first bracket is adjustable to allow repositioning of the first surface relative to the wall structure.

The first surface may be substantially flat and face horizontally.

In one form, the first surface is substantially flat and faces vertically upwardly.

In one form, the base assembly has a second bracket component that is selectively operatively attachable to the wall structure and defines a second surface for engaging a support so that the first and second surfaces cooperate to maintain the wall structure consistently in an operative orientation upon a support.

The first bracket component may be adjustable to allow the first surface to be repositioned relative to the second surface.

In one form, the first bracket component bounds at least a part of a U-shaped receptacle opening in a horizontal direction and into which a part of a support for the foliage container can be directed.

In one form, the first bracket component has a flat wall with a single flat surface facing horizontally.

In one form, the base assembly is reconfigurable to selectively: a) cooperate with a first type of support in the form of a vertically extending post by defining a receptacle into which the vertically extending post can be vertically translated so that the vertically extending post and base assembly are keyed against relative movement around a vertically extending axis; and b) cooperate with a second type of support having at least one surface against which the base assembly bears so that the foliage container can be translated horizontally from a separated position to cause the base assembly to bear against the at least one support surface.

In one form, the base assembly is reconfigurable to captively engage oppositely facing surfaces on an elongate support for the foliage container.

The foliage container may be provided in a combination with a vertically extending support to which the foliage container is attached.

In one form, the plurality of elongate elements includes at least one of wires and straps.

### BRIEF DESCRIPTION OF THE DRAWINGS

FIG. 1 is schematic representation of a system, according to the present invention, including a foliage container having a wall structure and a base through which the foliage container is connected to a support;

FIG. 2 is a schematic representation of the foliage container in FIG. 1 with a foliage insert placed in a receptacle defined by the wall structure;

FIG. 3 is a bottom perspective view of one form of foliage container as shown in FIG. 1;

FIG. 4 is a top perspective view of the foliage container in FIG. 3 in relationship to a support therefor, in the form of an upright post;

FIG. 5 is a reduced, side elevation view of the foliage container of FIGS. 3 and 4 operatively connected to an upright support upon which a mail box is mounted;

FIG. 6 is a view as in FIG. 5 wherein the upright support is part of a fence system;

FIG. 7 is a view as in FIG. 6 wherein the upright support 12 is part of a wall, as on a deck, or the like;

FIG. 8 is a perspective view of a modified form of foliage container on an upright support wall, as in FIG. 7;

FIG. 9 is a view as in FIG. 8 showing a modified form of wall structure on the foliage container;

FIG. 10 is a perspective view of a further modified form of foliage container connected to a support in the form of an elongate, vertically extending stake that can be supported, as through a subjacent surface;

FIG. 11 is a view as FIG. 10 of a modified form of foliage container with a support stake of the type shown in FIG. 10.

FIG. 12 is a fragmentary, perspective view of an upright support at the juncture between horizontally extending elements to which another form of foliage container, according to the present invention, is connected;

FIG. 13 is a bottom, perspective view of the foliage container in FIG. 12;

FIG. 14 is a bottom view of a modified form of base including two walls for straddling a support;

FIG. 15 is a view as in FIG. 14 of a modified form of base with a single wall on the base;

FIG. 16 is a side elevation view of a further modified form of base with adjustable straps to straddle a support;

FIG. 17 is a view as in FIG. 16 of a base with a modified form of strap;

FIG. 18 is a view as in FIGS. 15 and 16 wherein a dimension of a mounting receptacle defined by a base shown therein is variable;

FIG. 19 is a bottom view of the foliage container in FIGS. 3 and 4, modified to include a separate wall structure that is removable to provide two different configurations of base to cooperate with different supports;

FIG. 20 is a schematic representation of three different system combinations, according to the present invention, each including a foliage container and base assembly useable to maintain the foliage container in an operative orientation upon a support that can be any of virtually an unlimited number of different types;

FIG. 21 is a schematic representation of one form of base assembly including different bracket components that can be used either separately or together;

FIG. 22 is a schematic representation of a kit, according to the present invention, including a foliage container with bracket components that can be selectively used alone or together to produce desired mounting capabilities for different types of supports;

FIG. 23 is an exploded, perspective view of one form of foliage container, as shown in FIG. 20, with one form of base assembly designed to cooperate with a first type of support in the form of an upright post with a polygonal outer surface;

FIG. 24 is a bottom view of a part of the base assembly in FIG. 23;

FIG. 25 is a fragmentary, perspective view of a different type of support than is shown in FIG. 23 and in the form of a corner, as where rail components are joined;

FIG. 26 is a plan view of two different bracket components making up separate base assemblies that can be used to attach the foliage container of FIG. 23 to the corner structure of FIG. 25 at both inside and outside corners thereon;

FIG. 27 is a bottom view of the bracket component on the outside corner in FIG. 26;

FIG. 28 is an elevation view of the inverted bracket component of FIG. 27;

FIG. 29 is a view as in FIG. 28 of the bracket component in FIG. 26 for the inside corner;

FIG. 30 is an elevation view of the inverted bracket component in FIG. 29;

FIG. 31 is a view as in FIGS. 27 and 29 of a further modified form of bracket component cooperating with another type of support; and

FIG. 32 is a perspective view of a still further type of bracket component, according to the present invention.

### DETAILED DESCRIPTION OF THE DRAWINGS

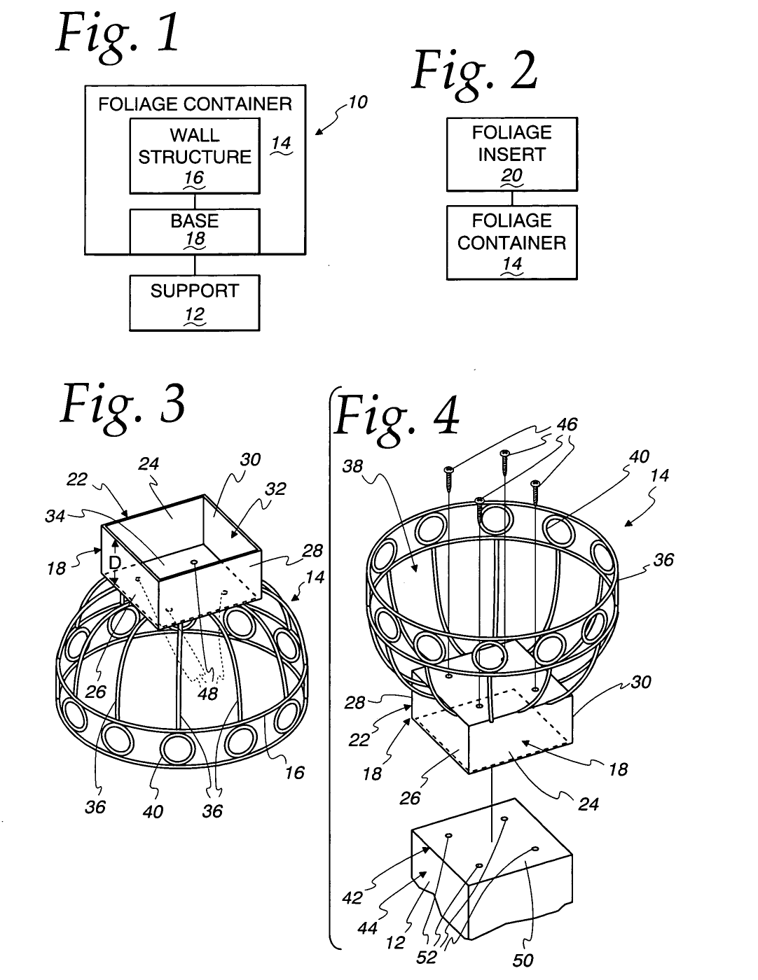

In FIG. 1, a system, according to the invention, is shown schematically at 10 that is a combination of a support 12 and foliage container 14. The foliage container 14 has a plurality of elongate elements that cooperatively produce a wall structure 16 bounding at least a part of a receptacle within which foliage can be placed. A base 18 is rigidly secured to the wall structure 16. The base 18 is configured to be rigidly connected to the support 12 so that the support 12 in turn can be used to rigidly maintain the wall structure 16 in an operative orientation. The support 12 and foliage container 14 are shown schematically in that they may take virtually a limitless number of different shapes, with exemplary forms as described below. What is consistent in the design is that the wall structure 16 is made from elongate elements that produce a skeletal-type wall structure 16 that bounds a foliage receptacle. The elongate elements may be straight, bent, circular, etc. to define a “see through” wall structure 16. They may be made from any rigid material, such as metal, plastic, rubber, a composite, etc.

As shown in FIG. 2, the receptacle defined by the wall structure 16 on the foliage container 14 is designed to accommodate a foliage insert 20. The foliage insert 20 may be another container, such as a conventional flower pot, a formed component made of compacted, porous material, such as shredded coconut, etc. Again, the foliage insert 20 is shown schematically in FIG. 2 to encompass virtually a limitless number of types of insert and shapes therefor that can be placed in the receptacle of the foliage container 14.

One specific form of the foliage container 14 is shown in FIGS. 3 and 4. In this embodiment, the base 18 consists of a wall structure 22 made up of four flat, rectangular, flat, walls 24, 26, 28, 30 arranged to cooperatively produce a square mounting receptacle 32 with a depth D. The mounting receptacle 32 is bounded by a horizontally extending, flat wall 34 that may be viewed as part of the base 18 and/or wall structure 16. The wall structure 22 of the base 18 is joined in relationship to the horizontal wall 34 so that the mounting receptacle 32 has an inverted cup shape.

In this embodiment, the wall structure 16 on the foliage container 14 is defined by elongate elements that are in the form of wires 36 that are welded or otherwise joined together to produce a desired shape that, in this case, bounds a cup-shaped receptacle 38 for the foliage insert 20, which receptacle 38 opens oppositely to the direction of opening of the mounting receptacle 32. The number, length, shape, arrangement, etc. of the wires 36 is not critical to the present invention. As also noted above, it is desirable that the wall structure 22 essentially be “skeletal” in nature to support the foliage insert 20 that can be observed therethrough. As still further noted previously, the designation “elongate elements” is intended to include the ring-shaped components 40 shown that, can each be considered to be a formed elongate element.

The base 18, which will be considered for purposes herein to include the horizontal wall 34, is configured to cooperate with the vertically extending support 12, shown in the form of an upright post with a top free end 42. The top end 42 of the upright post 12 has a peripheral shape/surface 44 that in this case is shown to be polygonal, and more particularly square, in shape. It is preferred that the peripheral shape/surface 44 conform at least nominally, and more preferably closely, to the shape around the mounting receptacle 32 bounded by the wall structure 22. With this conforming relationship, the base 18 can be frictionally connected to and rigidly maintained upon the upright post 12.

Alternatively, if there is but a nominal correspondence in shape, a rigid, fixed connection can be maintained by directing fasteners 46 through the receptacle 38 and into and through pre-formed openings 48 in the horizontal wall 34 and into a top surface 50 on the upright post 12, as indicated by the hole locations at 52.

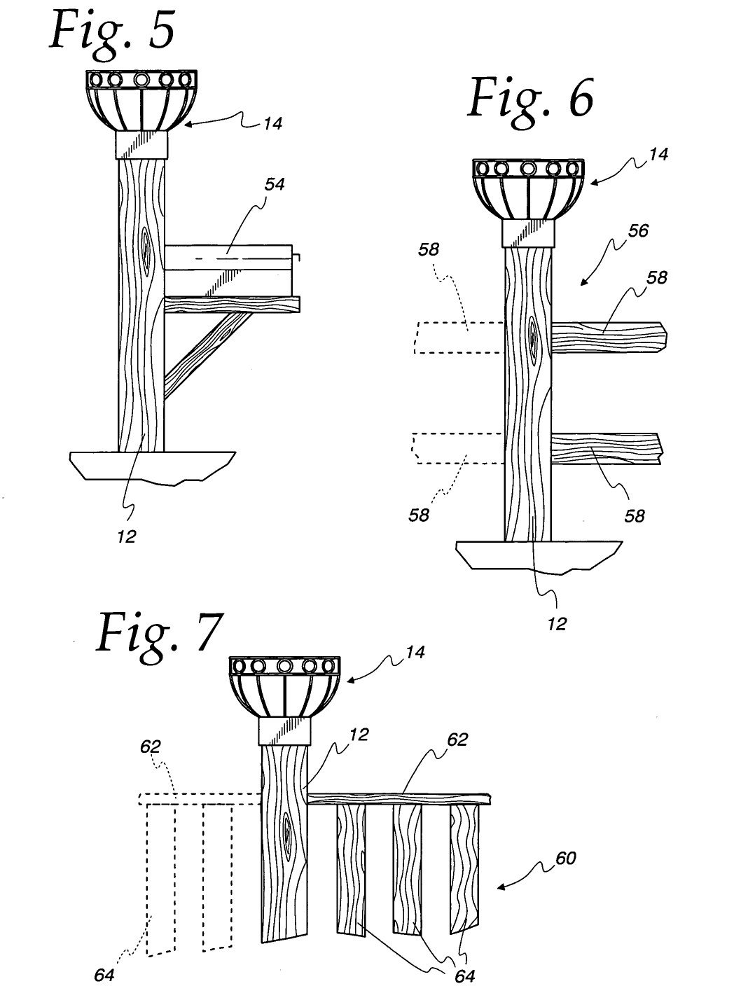

The wall structure 16 and base 18 on the foliage container 14 can be made from any suitable material, such as plastic, metal, or a composite. It is preferred that the base 18 be made from a material having a gauge sufficient to rigidly support the wall structure 16 in an operative orientation with respect to the upright post 12. The invention contemplates use of the above-described foliage container configuration in many diverse areas. As one example, as shown in FIG. 5, the upright post 12 may be used to support a mail box 54. The foliage container 14 provides a decorative addition thereto.

In FIG. 6, the upright post 12, to which the foliage container 14 is connected, is shown as part of a fence system at 56. The upright post 12 serves to support horizontal slats 58. The upright post 12 may be at a corner, with the slats 58 as shown in solid lines, or at a transition between sections of slats 58, as indicated by the slats 58 shown in dotted lines in FIG. 6.

In FIG. 7, the upright post 12 with the foliage container 14 thereon is shown integrated into a wall 60 associated with a deck, or the like. The wall 60 has a top rail 62 connected to vertical slats 64. The upright post 12 maybe provided at a corner, as shown in solid lines, or at a juncture between adjacent rail sections, which is indicated by the dotted lines showing of the additional top rail 62 and slats 64 in FIG. 7.

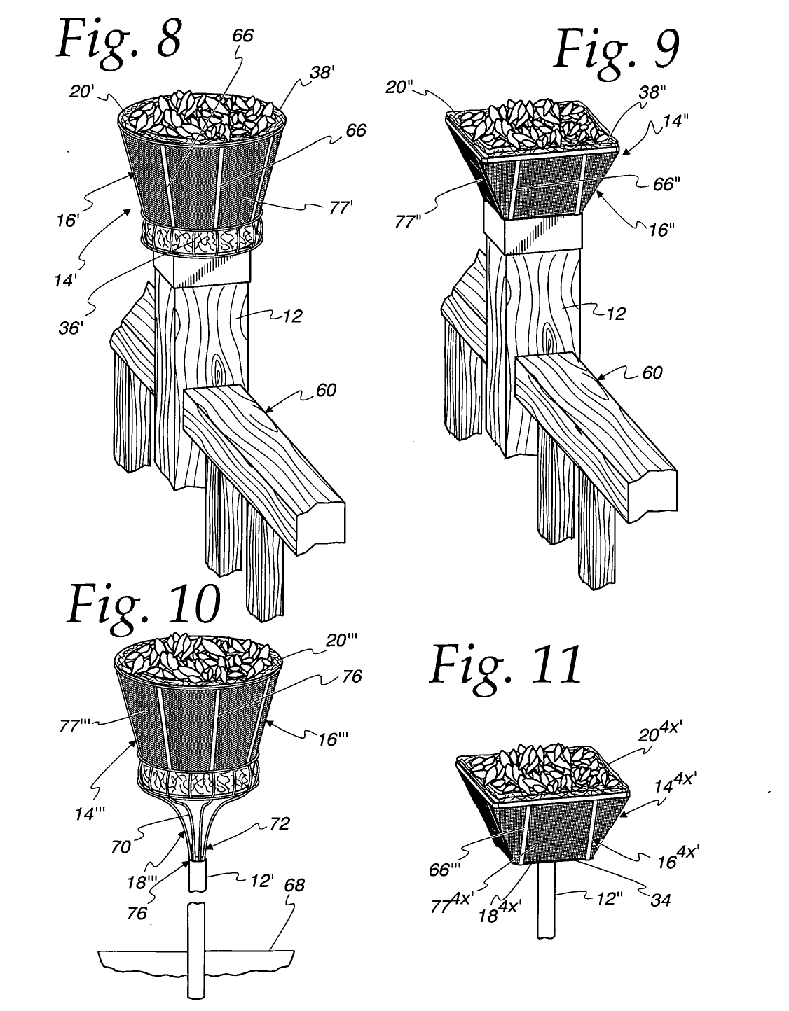

Different variations of the foliage container 14 are shown at 14′ and 14″ in FIGS. 8 and 9, respectively, on an upright post 12 that is part of a wall 60. The wall structure 16′ on the foliage container 14′ is made from a combination of round wires 36′ and flat wires in the form of straps 66 joined to produce a receptacle 38′ for the foliage insert 20′.

In FIG. 9, substantially the entire wall structure 16″ is made from straps 66″ to produce a receptacle 38″ for a foliage insert 20″.

In FIG. 10, a modified form of foliage container for a liner 20′″ is shown at 14′″ in association with a support 12′ that is in the form of an elongate stake that is directed through, and thereby supported with respect to, a subjacent surface 68. The stake 12′ may be driven into the ground or otherwise anchored, either permanently or temporarily.

In this embodiment, the base 18′″ is in the form of a plurality of formed wires 70 that connect between the wall structure 16′″ and the stake 12′. The lower ends 72 of the base wires 70 are directed into the top end 76 of the stake 12′ and suitably, fixedly secured thereto. The wires 70 may be joined to wires 76 on the wall structure 16′″, or may be contiguous therewith so that there is no clear division between the base 18′″ and wall structure 16′″.

A further modified form of foliage container is shown at 14^{4X′} in FIG. 11. In this embodiment, straps 66′″ are used to define the wall structure 16^{4X′} that accepts a liner 20^{4X′}. The straps 66′″ are joined to the base 18^{4X′} that is in the form of the aforementioned horizontal plate 34. An upright post/stake 12″ is connected to the base 18^{4X′} and can be suitably secured, as for the stake 12′ in FIG. 10.

In the embodiments shown in FIGS. 8-11, the liners 20′, 20″, 20′″, 20^{4X′} are each surrounded by a sheet layer 77′, 77″, 77′″, 77^{4X′} that confines any loose material making up the liners 20′, 20″, 20′″, 20^{4X′}.

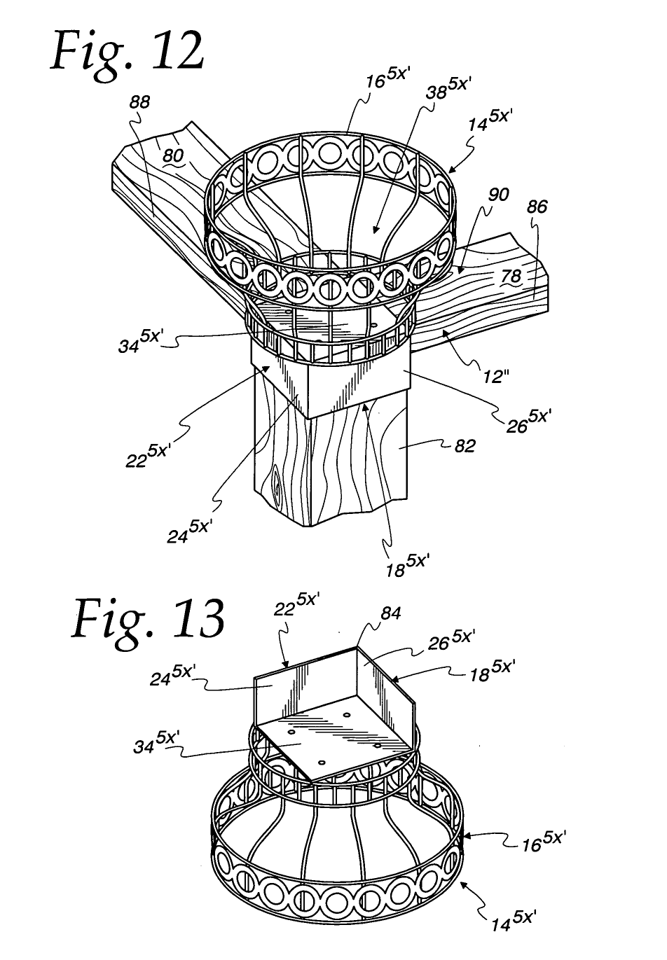

In FIGS. 12 and 13, a modified form of foliage container is shown at 14^{5X′} for use on a modified form of support 12″. The foliage receptacle 14^{5X′} is shown connected to the support 12″ at a corner location, as where horizontally extending elements 78, 80 meet at an upright corner support post 82.

In this embodiment, the base 18^{5X′} consists of a horizontal wall 34^{5X′} secured at the bottom of a wall structure 16^{5X′} defining a foliage receptacle 38^{5X′}. A wall structure 22^{5X′}, corresponding to the wall structure 22 shown in FIGS. 3 and 4, is made with but two walls 24^{5X′}, 26^{5X′} that meet at a corner 84.

With this arrangement, transverse, vertically extending, peripheral surfaces 86, 88 on the elements 78, 80, respectively, nest against the walls 26^{5X′}, 22^{5X′}, respectively at the corner 84. The horizontal wall 34^{5X′} bears upon an upwardly facing surface 90 defined by one or both of the elements 78, 80. Suitable fasteners (not shown) can be directed through the horizontal wall 34^{5X′} and/or wall structure 22^{5X′}, as desired, into one or any/all of the elements 78, 80 and corner support 82.

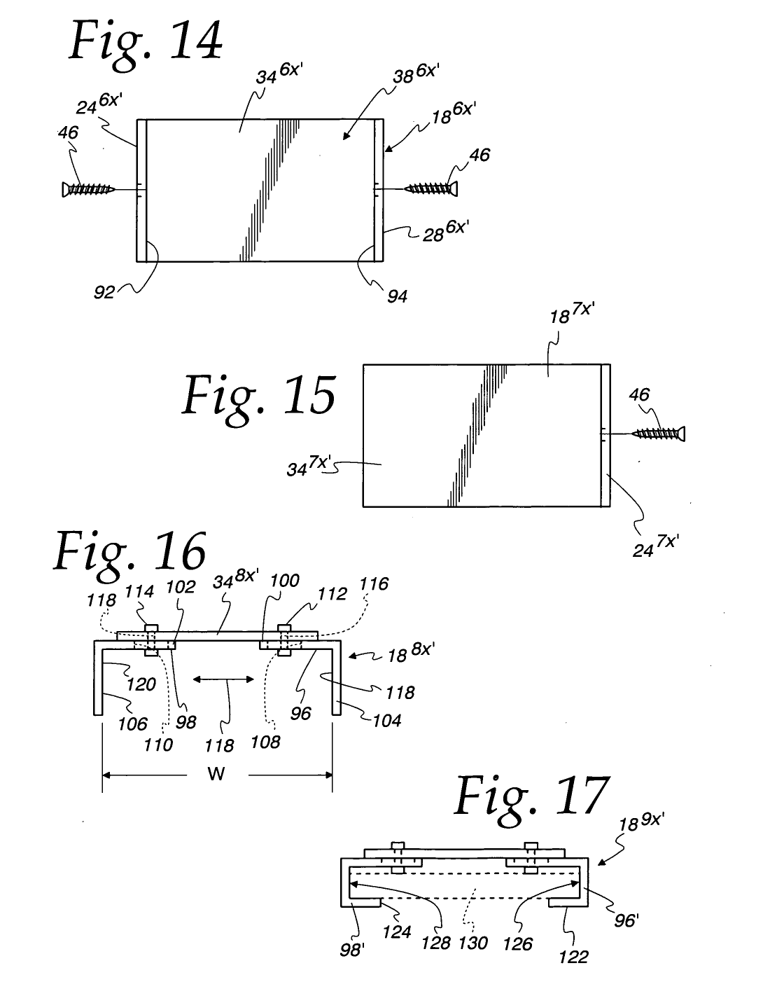

In FIG. 14, a modified form of the base is shown at 18^{6X′} with a horizontal wall 34^{6X′} having depending walls 24^{6X′}, 28^{6X′} with surfaces 92, 94, respectively, bounding a mounting receptacle 38^{6X′}. The planes of the surfaces 92, 94 are substantially parallel to straddle an element (not shown) that functions as a support therefor. Fasteners 46 can be directed through one or both of the walls 24^{6X′}, 28^{6X′} and/or through the horizontal wall 34^{6X′} to maintain the base 18^{6X′} rigidly connected to an associated support.

In FIG. 15, a further modified form of the base is shown at 18^{7X′} with a horizontal wall 34^{7X′} and depending wall 24^{7X′} that can be attached to an appropriate support using fasteners 46 extending through the wall 24^{7X′} and/or the horizontal wall 34^{7X′}.

As noted above, the base can be made with but a single, vertically extending wall having a surface that bears against a support surface. Alternatively, as in FIG. 14, a pair of vertically extending walls can be provided, each with flat surfaces that are substantially parallel to straddle a support.

In FIGS. 12 and 13, the pair of vertically extending walls have transverse surfaces to engage a support. In FIGS. 3 and 4, the wall structure fully surrounds an appropriate support. The invention contemplates that many other combinations of walls and surfaces thereon for a base might be devised by one skilled in the art, with the inventive principles in hand.

The invention also contemplates that the capacity of the base can be adjustable. In FIG. 16, a base is shown at 18^{8X′} with a horizontal wall 34^{8X′} having associated straps 96, 98. Each of the straps 96, 98 is L-shaped with horizontal legs 100, 102 and vertical legs 104, 106, respectively. The horizontal legs 100, 102 have elongate slots 108, 110 for fasteners 112, 114 directed through openings 116, 118 in the horizontal plate 34^{8X′}. The slots 108 and 110 allow the straps 96, 98 to be moved selectively towards and away from each other along the line of the double headed arrow 118, to thereby selectively vary the straddling width W between facing surface 118, 120 on the legs 104, 106. By loosening the fasteners 112, 114, an appropriate adjustment can be made, whereupon the fasteners 112, 114 can be re-tightened to maintain the desired relationship between the straps 96, 98. Connection of the base 18^{8X′} to a suitable support can be accomplished as described above.

In FIG. 17, a variation of the base of FIG. 16 is shown at 18^{9X′}. The base 18^{9X′} has straps 96′, 98′ functioning as the straps 96, 98 in FIG. 16, with the exception that the straps 96′, 98′ have a return bend 122, 124, respectively, to define U-shaped receptacles 126, 128 opening towards each other and designed to straddle the ends of the rectangular cross section of a support 130.

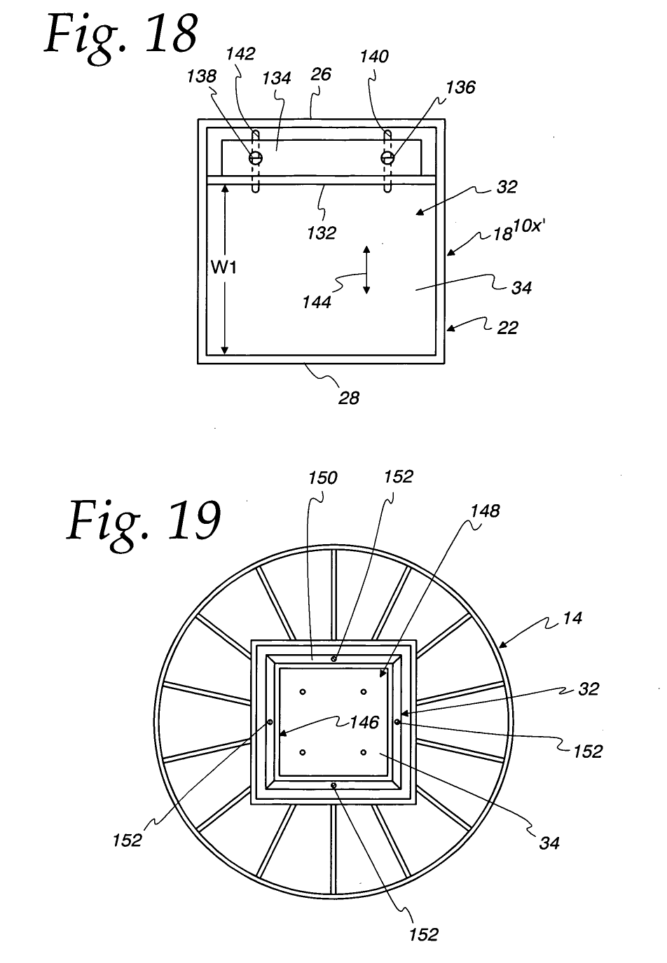

In FIG. 18, a further modified form the base is shown at 18^{10′} and consists of the aforementioned wall structure 22 and the horizontal wall 34. A wall 132 is provided within the mounting receptacle 32 and moveable guidingly between the walls 26, 28 to variably select a width dimension W1 between the walls 28, 132 for the mounting receptacle 32. The wall 132 has a transverse flange 134 through which fasteners 136, 138 extend. Elongate slots 140, 142 in the horizontal wall 34 allow fasteners 136, 138 directed therethrough to slide guidingly as the wall 132 moves in the direction of the double headed arrow 144. The fasteners 136, 138 can be tightened to maintain a desired width dimension W1. The base 18^{10X′} can be attached to an appropriate support, as described above. The wall 132 may be separated by releasing the fasteners 136, 138.

In FIG. 19, a further modification to the foliage container 14 is shown. A squared wall structure 146 is mounted removably within the mounting receptacle 32 and has a smaller size mounting receptacle 148. The wall structure 146 has a peripheral, outturned flange 150 through which the wall structure 146 is releasably secured to the horizontal wall 34 through fasteners 152.

With this structure, the user has the option of using the wall structure 146 having the smaller dimension mounting receptacle 148. Alternatively, the fasteners 150 can be removed to separate the wall structure 146, whereupon the wall structure 22 can be utilized as previously described.

As an alternative to having the wall structures 22, 146 merely scaled in size, they may define different shapes for the mounting receptacle 32, 148 to accommodate different supports.

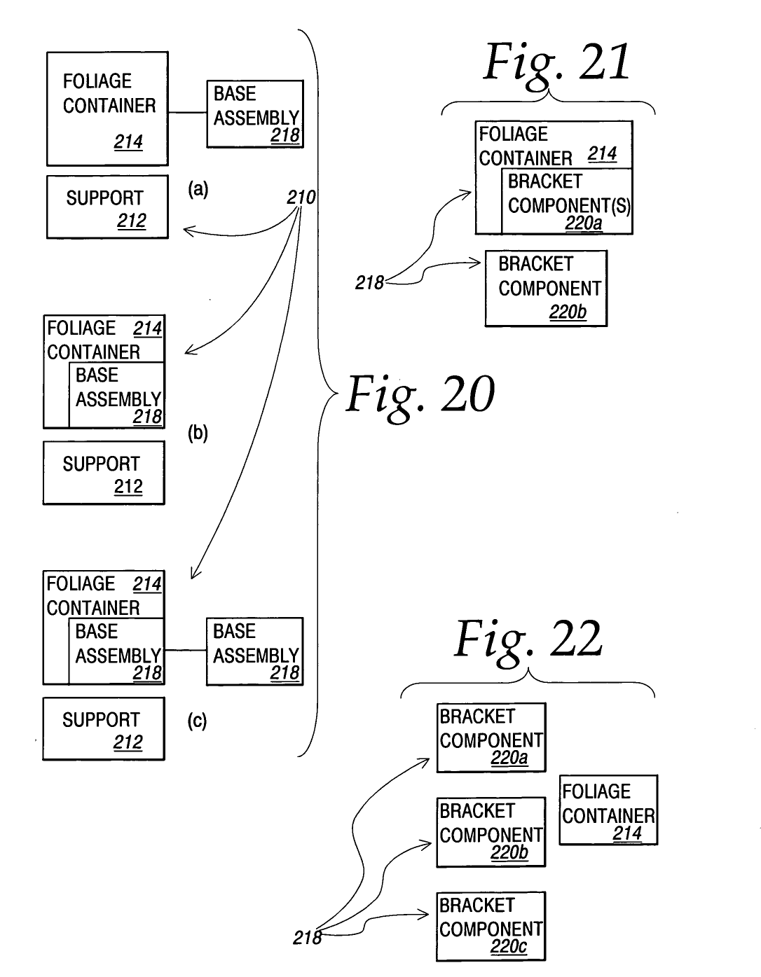

In FIG. 20, other configurations of the inventive system are shown at 210, in three different forms: (a); (b); and (c). Each of the system forms consists of a support 212 upon which a foliage container 214 is rigidly supported. The foliage container 214 is of the same general nature as the foliage container 14, with a wall structure made from elongate elements that produce a skeletal shape that bounds a foliage container. The foliage container 214 is rigidly mounted upon the support 212 by a base assembly 218. In generic form (a), the base assembly 218 is separate from the foliage container 214. In generic form (b), the base assembly 218 is shown as part of the foliage container 214. In generic form (c), the base assembly 218 consists of a part that is integral with the foliage container 214 and a part that is separate therefrom. These and other generic forms of the inventive system are contemplated.

In FIG. 21, the foliage container 214 is shown generically with the base assembly 218 consisting of at least one bracket component 220a on the foliage container 214 and a separate bracket component 220b that is selectively operatively attachable to the foliage container 214.

In FIG. 22, the foliage container 214 is shown with three separate bracket components 220a, 220b, 220c that can be selectively operably attached to the foliage container 214. The invention contemplates that one, two or three of the bracket components 220a, 220b, 220c shown could be offered with the foliage container 214 as a kit and selectively utilized individually or in any combination.

It is contemplated that each of the bracket components 220a, 220b, 220c be useable to reconfigure the base assembly 218 to cause the base assembly 218 to be rigidly connected to the foliage container 214 by cooperating with different types of supports in different manners. Each bracket component, by reason of being attached to or separated from the foliage container 214, accounts for a reconfiguration of the base assembly 218 that allows it to cooperate with another type of support in a different manner, thereby to maintain the foliage container 214 consistently in an operative orientation with respect to the support 212. Specific forms of the foliage container 214 and base assembly 218 will now be described.

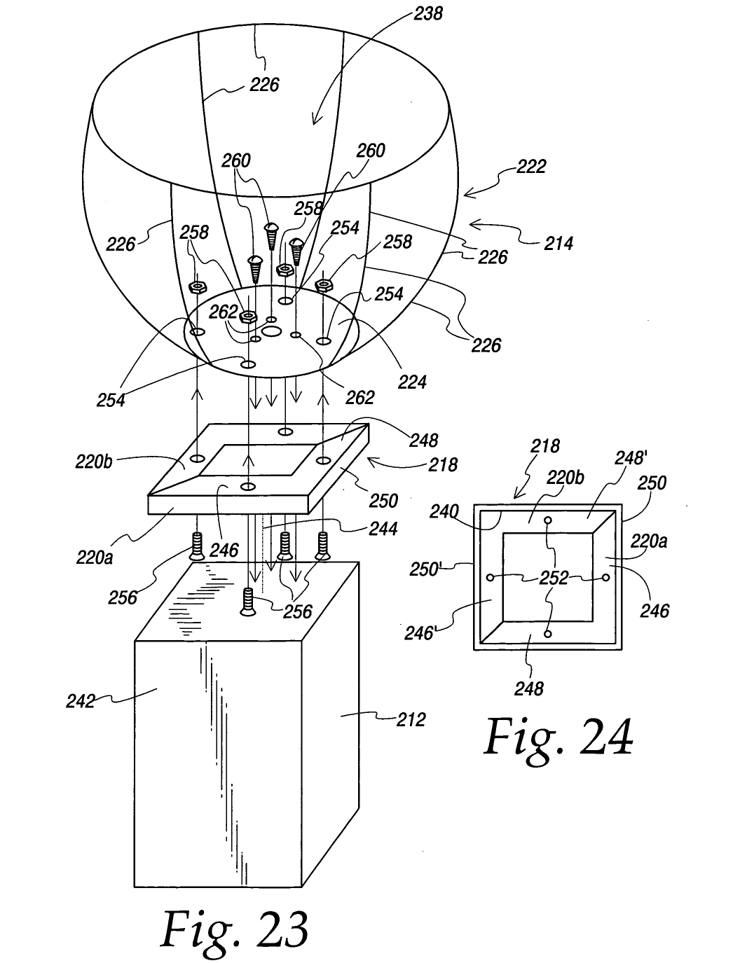

In FIG. 23, one form of foliage container 214 is shown consisting of a wall structure 222, corresponding to the wall structure 22, previously described, and generally consistent in construction therewith. The foliage container 214 consists of the wall structure 222 and a horizontally extending, flat wall 224 to which elongate elements 226 are attached, as by welding, to produce a receptacle 238, corresponding to the receptacle 38, previously described, in form and function. The horizontally extending flat wall 224 can be considered, for purposes of the detailed description and claims herein, as part of both the foliage container 214 and base assembly 218.

In FIG. 23, the foliage container 214, including the horizontally extending flat wall 224, can be made with a generic construction and provided as part of a kit, in combination with one or more of the bracket components 220a, 220b, 220c, etc. In FIG. 23, the base assembly 218 consists of first and second bracket components 220a, 220b that are used together to bound a receptacle 240 for a support 212, shown as an upright post with a polygonally-shaped, peripheral surface 242. In this case, the surface 242 has a squared shape to which the receptacle 240 is matched so that the base assembly 218 and support 212 can be keyed against relative rotation around a vertical center axis 244 for the support 212.

In this embodiment, each of the bracket components 220a, 220b has the same configuration. Exemplary bracket component 220a has an “L” shape with transverse legs 246, 248 from which an outer wall 250 depends. The bracket component 220b has corresponding legs 246′, 248′ and a depending outer wall 250′.

The bracket components 220a, 220b have openings 252 alignable, one each, with openings 254 in the wall 224. The openings 252, 254 are strategically situated so that with the openings 252, 254 registered, the bracket components 220a, 220b align to cooperatively define the downwardly opening receptacle 240 in the squared configuration shown.

With the openings 252, 254 registered, releasable fasteners, such as threaded bolts 256, can be directed therethrough and secured by nuts 258. The bolts 256 maintain the bracket components 220a, 220b fixedly operatively attached to the wall structure 222 through the wall 224.

Screws 260, or the like, can be directed through openings 262 in the wall 224 to secure the unitary container 214 and base assembly 218 to the support 212.

The operatively attached bracket components 220a, 220b allow the base assembly 218 to cooperate with the post 212 in a first manner to maintain the wall structure 222 consistently in an operative orientation rigidly upon the support 212. While the base assembly 218 in FIGS. 23 and 24 is shown as being made up of two different bracket components 220a, 220b, the entire square configuration shown could be defined by a single, separable bracket component. The use of cooperating bracket components 220a, 220b, as shown, is preferred from the standpoint that one of the bracket components 220a, 220b might be separated to allow the other of the bracket components 220a, 220b to cooperate with a different type of support in a different manner to maintain the wall structure 222 consistently in an operative orientation thereupon.

For example, as shown in FIGS. 25-28, the exemplary bracket component 220a may be used alone on the wall 224 to facilitate mounting to a support in the form of a corner structure, as shown at 264, that may be at the juncture of two horizontally extending rail components 266, 268. The corner structure has transverse, flat surfaces 270, 272 which define an outside corner 273 that nests in a receptacle 274 defined by the bracket component 220a. With the bracket component 220a attached to the wall 224, the foliage container 214 can be situated to have the receptacle 274 and outside corner 273 at the same vertical height and spaced horizontally from each other, whereupon the container 214 can be translated, generally in the direction of the arrow 276 in FIG. 26, to cause the surfaces 270, 272 at the corner 273 to nest in the receptacle 274, whereupon the container 214 and associated wall structure 222 is consistently maintained in an operative orientation upon the support/corner structure 264. The container 214 can be maintained in its operative orientation with or without the use of separate fasteners.

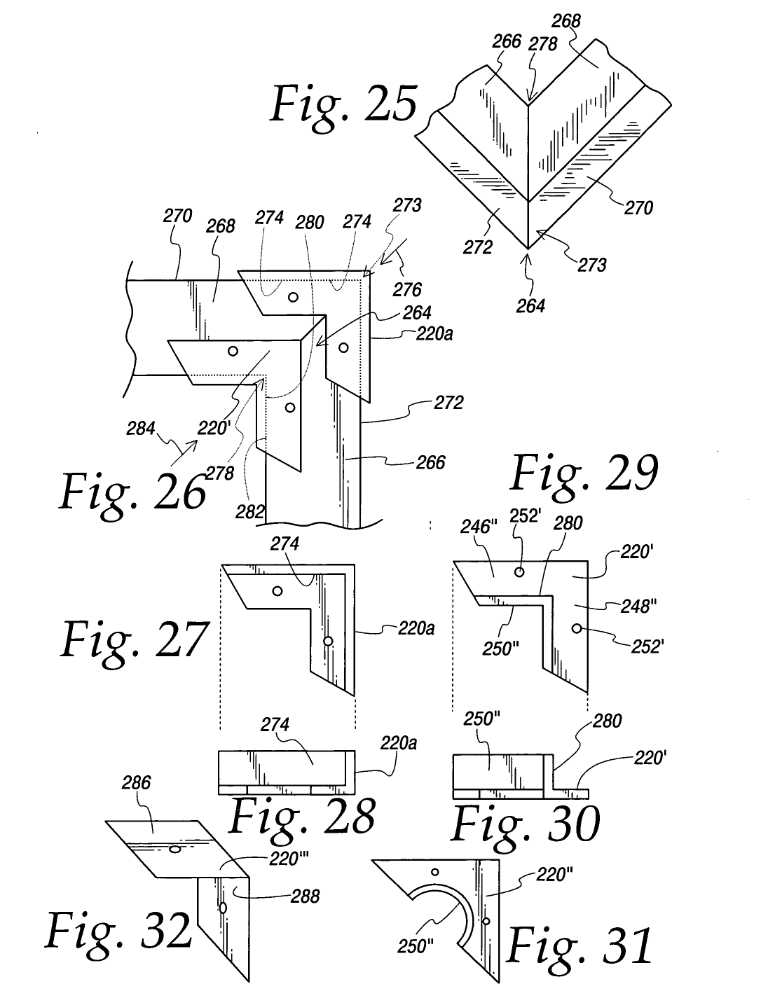

As an alternative to using the bracket component 220a for cooperation with the outside corner 273, a bracket 220′, as shown in FIGS. 26, 29 and 30, can be used to cooperate with an inside corner 278 on the same corner structure 264.

The bracket component 220′ has the same angled configuration as the bracket component 220a, including transverse legs 246″, 248″. A corresponding wall 250″ depends from the legs 246″, 248″ on the inside rather than the outside thereof, thereby forming a V-shaped/angled surface 280 that nests in a complementarily-shaped receptacle 282 formed at the inside corner 278 of the corner structure 264.

With the bracket component 220′ attached to the container 214 using releasable fasteners 256 (FIG. 23), extending through holes 252′, the surface 280 on the bracket component 220′ can be aligned at the same vertical height as the inside corner 278 and translated horizontally in the direction of the arrow 284 to nest the surface 280 within the inside corner 278. Fasteners (not shown) could be directed through the wall 250″ into one or both of the rail components 266, 268 to secure the connection. Alternatively, if the container 14 is large enough, it will bridge the rail components 266, 268 to be stably supported thereupon.

Many variations from the above-described basic base assemblies/bracket components are contemplated. As just one example, as shown in FIG. 31, the bracket component 220″ is shown with a curved, inner wall 250″ to cooperate with a complementarily-shaped post or other supporting structure.

A further modified form of base assembly/bracket component is shown at 220′″ in FIG. 32. The bracket 220′″ has a mounting leg 286 and a transverse, depending leg 288. With the bracket component 220′″ attached to the wall 224, the leg 288 defines a flat surface, that faces horizontally and may be borne against a support as described with respect to FIG. 15.

The bases shown at 18^{8X′} and 18^{9X′} in FIGS. 16 and 17 can likewise make up base assemblies that can be afforded as an optional structure as part of the inventive kit. That is, the straps 96, 96′, 98, 98′ are additional “bracket components” that can be offered to a user and selectively releasably attached to the wall 224. This configuration of base assembly provides flat horizontally and vertically extending surfaces that are adjustable relative to an associated support.

Further variations of base assemblies/bracket components are contemplated, with additional arrangements such as shown, for example, in FIGS. 13 and 14.

The invention contemplates that the basic foliage container 214, including the wall structure 222 and flat wall 224, can be sold in conjunction with one or more of the base assemblies. The base assemblies can be sold with the foliage container 214 as a kit with any combination of mounting capabilities, as described above. Alternatively, at point of sale, the foliage container 214 can be sold with the user having the option of selecting the desired base assembly components that can be interchangeably attached to the flat wall 224 to select the desired mounting capability, that is dictated by the type of support. By reconfiguring the base assembly through selective use/attachment of components on the wall 224, different mounting capabilities can be conveniently selected. The base assembly configurations shown above are representative in nature only as virtually an unlimited number of different other forms thereof can be provided, either individually or in combination, to afford the desired mounting capability. Further, the precise manner of attaching the components shown, as through the wall 224, is exemplary in nature only. The invention contemplates any structure that allows selective releasable attachment of components to cooperate with different supports in different manners.

Also, in each embodiment, it is contemplated that openings may be provided in depending base assembly components to allow fasteners to be directed generally horizontally therethrough into the selected support. This potentially allows the foliage containers to be pre-filled with liners and/or foliage and secured with the liners and/or foliage in place.

The foregoing disclosure of specific embodiments is intended to be illustrative of the broad concepts comprehended by the invention.

1. A foliage container comprising:
a plurality of elongate elements that cooperatively produce at least a part of a wall structure bounding a receptacle into which foliage can be placed; and
a base assembly that is configured to be rigidly connected to the wall structure and that is reconfigurable to cooperate with different types of supports in different manners to maintain the wall structure consistently in an operative orientation in relationship to each of different types of supports.

2. The foliage container according to claim 1 wherein the base assembly comprises at least a first bracket component that is selectively operatively attachable to the wall structure, the base assembly configured so that a) with the first bracket component separate from the wall structure, the base assembly is configured to cooperate with a first type of support in a first manner; and b) with the first bracket component operatively attached to the wall structure, the base assembly is configured to cooperate with a second type of support in a second manner that is different than the first manner.

3. The foliage container according to claim 2 wherein with the first bracket component separate from the wall structure the base assembly defines transverse surfaces cooperatively defining an angled receptacle opening in a horizontal direction and into which a support can be directed by being translated horizontally relative to and against the transverse surfaces.

4. The foliage container according to claim 3 wherein the base assembly comprises a second bracket component that is configured to be selectively operatively attached to the wall structure and defines the transverse surfaces.

5. The foliage container according to claim 4 wherein with the first and second bracket components operatively attached to the wall structure the first and second bracket components cooperatively bound a receptacle for a support for the foliage container.

6. The foliage container according to claim 5 wherein with the first and second bracket components operatively attached to the wall structure, the first and second bracket components cooperatively bound a receptacle for a support that has a polygonal shape.

7. The foliage container according to claim 5 wherein the first and second bracket components are each selectively operatively attachable to the wall structure through at least one releasable fastener.

8. The foliage container according to claim 7 wherein the at least one releasable fastener is a threaded fastener.

9. The foliage container according to claim 2 wherein the base assembly comprises a horizontally extending wall to which the first bracket assembly is separately attachable.

10. The foliage container according to claim 9 wherein there is at least one opening in the horizontally extending wall to accept a fastener that can be directed into a support for the foliage container.

11. The foliage container according to claim 1 wherein the base assembly comprises a first bracket component that is selectively operatively attachable to the wall structure and defines a first surface for engaging a support for the foliage container and the first bracket is adjustable to allow repositioning of the first surface relative to the wall structure.

12. The foliage container according to claim 11 wherein the first surface is substantially flat and faces horizontally.

13. The foliage container according to claim 11 wherein the first surface is substantially flat and faces vertically upwardly.

14. The foliage container according to claim 11 wherein the base assembly comprises a second bracket component that is selectively operatively attachable to the wall structure and defines a second surface for engaging a support so that the first and second surfaces cooperate to maintain the wall structure consistently in an operative orientation upon a support.

15. The foliage container according to claim 14 wherein the first bracket component is adjustable to allow the first surface to be repositioned relative to the second surface.

16. The foliage container according to claim 11 wherein the first bracket component bounds at least a part of a U-shaped receptacle opening in a horizontal direction and into which a part of a support for the foliage container can be directed.

17. The foliage container according to claim 2 wherein the first bracket component comprises a flat wall with a single flat surface facing horizontally.

18. The foliage container according to claim 1 wherein the base assembly is reconfigurable to selectively a) cooperate with a first type of support in the form of a vertically extending post by defining a receptacle into which the vertically extending post can be vertically translated so that the vertically extending post and base assembly are keyed against relative movement around a vertically extending axis; and b) cooperate with a second type of support having at least one surface against which the base assembly bears so that the foliage container can be translated horizontally from a separated position to cause the base assembly to bear against the at least one support surface.

19. The foliage container according to claim 18 wherein the base assembly is reconfigurable to captively engage oppositely facing surfaces on an elongate support for the foliage container.

20. The foliage container according to claim 1 in a combination with a vertically extending support to which the foliage container is attached.

21. The foliage container according to claim 1 wherein the plurality of elongate elements comprises at least one of wires and straps.
